(19) United States
(12) Patent Application Publication
(10) Pub. No.: US 2016/0063481 A1
(43) Pub. Date: Mar. 3, 2016

(54) System and Method of Electronic Authentication at a Computer Initiated Via Mobile

(71) Applicant: MasterCard International Incorporated, Purchase, NY (US)

(72) Inventors: Akshat Gupta, Vernon, CT (US); Magdy Hassan, Cairo (EG); Youssef Khanachat, Beirut (LB); Khaled Ellayar, Cairo (EG); Umar Hashmi, Dubai (AE)

(21) Appl. No.: 14/839,622

(22) Filed: Aug. 28, 2015

Related U.S. Application Data
(60) Provisional application No. 62/043,594, filed on Aug. 29, 2014.

(51) Int. Cl. G06Q 20/32; G06Q 20/10; G06Q 20/40

(52) U.S. Cl. CPC G06Q 20/3229; G06Q 20/4012; G06Q 20/3223; G06Q 20/1085; G06Q 2220/00

(57) ABSTRACT

A system, method, and computer-readable storage medium configured to facilitate cash transactions at an Automated Teller Machine when an ATM card is not present, regardless of whether the accountholder is a customer of the financial institution that owns the ATM.

### RELATED APPLICATIONS

This application claims priority to a U.S. Provisional Patent Application Ser. No. 62/043,594, filed on Aug. 29, 2014, entitled “System and Method of Facilitating Card Less Transactions at an ATM without an ATM Card Initiated via Mobile,” the contents of which are incorporated herein by reference.

### BACKGROUND

1. Field of the Disclosure

Aspects of the disclosure relate in general to computer science, and more specifically computer access control. Aspects include an apparatus, system, method and computer-readable storage medium to authenticate a user at a computer to facilitate various electronically authenticated transactions at the computer.

2. Description of the Related Art

Authenticating authorized users at a computer, computer terminal, or computer kiosk is a complex problem.

Authentication at a computer or computer terminal can be accomplished using knowledge that an authorized user knows, such as a password.

Some other types of computers require two-factor authentication. For example, an Automated Teller Machine or Automatic Teller Machine (ATM), also known as an Automated Banking Machine (ABM), or cash machine, is an electronic telecommunications device that enables the consumers of a financial institution to perform financial transactions without the need for a human cashier, clerk or bank teller.

On ATMs, the consumer is identified by inserting a plastic ATM card with a magnetic stripe or a plastic smart card with a chip that contains a unique card number and some security information such as an expiration date, card verification value code (CVVC), or card verification code (CVC or CVC2). Authentication is provided by the Consumer entering a personal identification number (PIN).

Using an ATM, Consumers can access their bank deposit or credit accounts in order to make a variety of transactions such as cash withdrawals, check balances, or deposit cash. If the currency being withdrawn from the ATM is different from that in which the bank account is denominated the money is converted at an official exchange rate. Thus, ATMs often provide the best possible exchange rates for foreign travelers, and are widely used for foreign exchange.

### SUMMARY

Embodiments include a system, device, method and computer-readable medium to authenticate a user to facilitate various transactions at electronic kiosk or computer.

In one embodiment, the apparatus includes a processor and a network interface. The network interface is configured to receive a cash deposit request. The cash deposit request includes a customer Mobile Station International Subscriber Directory Number (MSISDN), a mobile PIN (m-PIN), and an amount of the cash deposit. The processor formulates an International Standards Organization (ISO) cash-in message construct. The ISO message construct includes the MSISDN, the m-PIN, and the amount of the cash deposit. The network interface transmits the ISO cash-in message to a mobile payments gateway (for example, the MasterCard Mobile Payments Gateway). The network interface receives a user authentication response from the mobile payments gateway. The user authentication response includes: an accountholder Primary Account Number (PAN) associated with the MSISDN and m-PIN. The processor identifies an issuer identified by the accountholder PAN. The processor then formulates an account-to-account payment transaction message (for example, a MasterCard MoneySend® or Visa OCT message). The payment transaction message includes: the accountholder PAN, and the amount of the cash deposit. The network interface transmits the payment transaction message to the issuer identified by the account PAN.

In another embodiment, the apparatus includes a processor and a network interface. The network interface is configured to receive an Account Value Load (AVL) request. The Account Value Load request includes a customer Mobile Station International Subscriber Directory Number (MSISDN), a mobile PIN (m-PIN), a receiving account number, and an amount of a deposit. The processor formulates an International Standards Organization (ISO) funding message construct. The ISO message construct includes the MSISDN, the m-PIN, and the amount of the deposit. The network interface transmits the ISO funding message to a mobile payments gateway. The network interface receives a user authentication response from the mobile payments gateway. The user authentication response includes: an accountholder Primary Account Number (PAN) associated with the MSISDN and m-PIN. The processor identifies a funding issuer identified by the accountholder Primary Account Number and identifies a receiving issuer identified by the receiving account number. The processor then formulates an account-to-account funding transaction message (for example, a MasterCard MoneySend® or Visa OCT message), the funding transaction message including: the accountholder PAN, and the amount of the deposit. The processor formulates a payment transaction message, the payment transaction message including: the receiving account number, and the amount of the deposit. The network interface transmits the funding transaction message to the funding issuer identified by the accountholder PAN, and transmits the payment transaction message to the receiving issuer identified by the receiving account number.

In another embodiment, the apparatus includes a processor and a network interface. The network interface is configured to receive a cash-out request from an Automated Teller Machine (ATM). The cash-out request includes a customer Mobile Station International Subscriber Directory Number (MSISDN), a mobile PIN (m-PIN), a receiving account number, and an amount of a withdrawal. The processor matches the MSISDN and m-PIN to a Primary Account Number. The processor generates a generated one-time password when the MSISDN and m-PIN are matched to the Primary Account Number. The network interface transmits the generated one-time password to a mobile phone designated by the MSISDN. The network interface receives a confirmation one-time password from the ATM. The processor confirms that the confirmation one-time password is the same as the generated one-time password. When the processor confirms that the confirmation one-time password is the same as the generated one-time password, the processor formulates an account-to-account cash-out transaction message (for example, a MasterCard MoneySend® or Visa OCT message). The cash-out transaction message includes: the accountholder PAN, and the amount of the cash withdrawal. The network interface transmits the cash-out transaction message to the issuer identified by the account PAN, and transmits a cash-out transaction authorization to the ATM when the issuer sends an issuer authorization, otherwise transmitting a decline message to the ATM.

### BRIEF DESCRIPTION OF THE DRAWINGS

FIG. 1 illustrates a process flow of authenticating a user where physical cash is used for deposits at an ATM when an ATM card is not present, regardless of whether the accountholder is a customer of the financial institution that owns the ATM.

FIG. 2 depicts a process of authenticating a user where an Account Value Load is used to deposit in another account, at an ATM, when an ATM card is not present, regardless of whether the accountholder is a customer of the financial institution that owns the ATM.

FIG. 3 illustrates a process flow of authenticating a user where a one-time-password is generated for a cash withdrawal at an ATM when an ATM card is not present, regardless of whether the accountholder is a customer of the financial institution that owns the ATM.

FIG. 4 is a process flow of authenticating a user where a cash withdrawal at an ATM when an ATM card is not present, regardless of whether the accountholder is a customer of the financial institution that owns the ATM.

### DETAILED DESCRIPTION

One aspect of the disclosure includes the realization that in many areas of the world many people cannot use conventional two-factor authentication at some computers because they do not have an electronic identifier, such as an ATM card. Another aspect of the disclosure is the realization that many such people may have a mobile phone, which can be used to verify the identity of a user at an Automated Teller Machine. For the purposes of this disclosure, the Automated Teller Machine and mobile phone user may also be referred to as a customer or accountholder.

Some ATM card issuers provide service to their customers using the issuer's ATMs by verifying the identity of the customer via a mobile phone. For example, suppose that an individual is a customer of the First National Bank. Using their mobile phone, the First National Bank customer can perform a transaction at a First National Bank ATM when an ATM card is not present. Conventionally, however, this functionality is not available if the First National Bank customer uses a non-First National Bank ATM (i.e. an ATM not owned by the First National Bank).

Another aspect of the disclosure is the realization that a payment network, using a mobile payment gateway, can facilitate a financial transaction at an ATM in circumstances when the ATM customer is not using an ATM owned by the issuer. In such an example, using their mobile phone, the First National Bank customer can perform a transaction at a Second National Bank ATM even if their ATM card is not present.

The following description of the embodiments is provided to enable any person skilled in the art to practice the disclosure. For illustrative purposes the embodiments are describe authenticating a user using an example electronic kiosk that is an Automated Teller Machine.

Embodiments of the present disclosure include a system, method, and computer-readable storage medium configured to use a mobile phone to facilitate various (cash based and non-cash based) transactions at an Automated Teller Machine when an ATM card is not present, regardless of whether the mobile phone user (accountholder) is a customer of the financial institution that owns the ATM. In one embodiment, a Consumer is identified in an ATM transaction using a Mobile Station International Subscriber Directory Number (MSISDN), which is a number uniquely identifying a subscription in a Global System for Mobile Communications (GSM) or a Universal Mobile Telecommunications System (UMTS) mobile network. The MSISDN is generally the telephone number on the Subscriber Identity Module (SIM) card in a mobile phone.

In such an embodiment, a payment network is a mobile payment facilitator and partners with various ATM account issuers. A payment network ensures that all mobile transactions processes off of an ATM account that is mapped to an accountholder's mobile number, also known as the Mobile Station International Subscriber Directory Number. With an ATM account linked to an accountholder's registered mobile phone, the accountholder can utilize other payment network programs, such as government and employee disbursements.

Embodiments of the disclosure include a method to authenticate a user in a transaction to deposit and withdraw cash using the mobile prepaid accounts and the payment network. These methods—Mobile at ATM for Cash-in and Mobile at ATM for Cash-out—enable registered accountholders to perform transactions at any ATM that displays the payment network mobile acceptance mark creating interoperability between various participating issuers. The payment network implements standards to permit payment network mobile acceptance at the ATM. This allows accountholders to access any participating ATM, subject to acquirers completing integration between their ATM Switch and the mobile payment gateway (MPG). The MPG allows card issuers to link or issue card accounts and mobile wallets to consumers' mobile phones through a mobile network operator (MNO). Consumers may be provided with a PIN to allow access to their accounts or wallet through their mobile phone (a mobile-PIN or m-PIN)

In some embodiments, consumers are authenticated against m-PIN for mobile wallet transactions.

In other embodiments, consumers are authenticated against the m-PIN for the funding account. In such transactions, the transactions are classified as account-to-account transactions (for example, MasterCard MoneySend® or Visa OCT messages), which follow payment network rules.

Mobile at ATM for Cash-in (Deposits)

An embodiment payment network authenticates a user and offers registered accountholders the ability to cash in (deposit) funds using physical cash to their mobile prepaid account using ATMs that display the payment network mobile acceptance mark.

When physical cash is used, then during the authentication phase, each accountholder enters his or her registered mobile number (MSISDN) and corresponding mobile PIN (m-PIN) into the ATM keypad. The m-PIN may be validated by the MPG prior to the cash in transaction. When conducting the actual cash-in transaction, the m-PIN is not required to be entered again. In such cases, the payment network reminds customers that the consumer's m-PIN is validated by the MPG before the cash in deposit transaction, and issuers are responsible for any fraud-related losses.

The transaction is managed by the ATM Switch, which is responsible for managing the transaction with the ATM, MPG, and payment network. This way, the ATM cash in transaction uses pre-existing ATM card processing networks and procedures and the ATM Switch relies upon the MPG to authenticate the accountholder's credentials, retrieve the primary account number (PAN), and then submit the transaction to the payment network.

Mobile Money

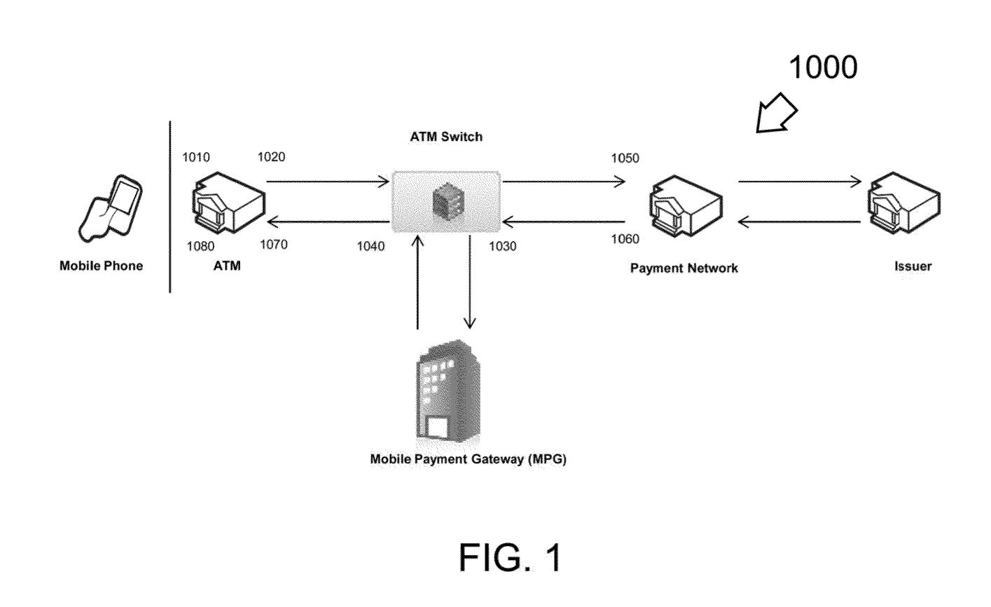

FIG. 1 illustrates a method 1000 of authenticating a user where physical cash is used for “cash-in” deposits, constructed and operative in accordance with an embodiment of the present disclosure.

At block 1010, Accountholder selects the option to deposit cash into the ATM at the ATM user interface and requests to deposit the amount directly to his or her registered mobile-specific wallet and perform the cash-in action. Once the Consumer selects the appropriate option, the ATM additionally requests the consumer to enter their MSISDN and m-PIN along with the dollar amount that is being deposited.

The ATM sends the request to ATM Switch containing, among other data elements, the consumer's MSISDN, m-PIN and the amount deposited information by the accountholder, block 1020.

At block 1030, the ATM Switch sends the cash-in request to MPG containing, among other data elements, the following:
Service (Cash-In/Cash-Out),
Accountholder MSISDN,
Authorization Data (m-PIN),
Ceiling Amount, and
Acquirer Terminal ID.

In some embodiments, the cash-in request is sent as an International Organization for Standardization (ISO) message construct. Such message constructs are defined by ISO 8583. The ISO message construct may be formulated as follows:

Funding Transaction (Cash);

Payment Transaction:

DE 3 s1=28

DE 18=6536/6537

DE 22 SF 1=82 (PAN auto-entry via server)

DE 48 (TCC)=P

DE 48 SF 23=01 (Mobile Phone or smartphone)

DE 48 SF 48

SE 1=1 or 2

SE 2=currently defined as 09

DE 48 SE 77 (Payment Transaction Type)=C52

DE 61
SF 3 (Terminal Location)=2 (off premises)
SF 4 (POS Accountholder Presence)=5 (ecommerce)
SF 5 (POS Card Presence)=1 (card not present)
SF 6 (POS Card Capture=0 (no card capture cap.)
SF 10 (CAT Level)=6 (ecommerce)

DE 124=If Sender name is unknown use card acceptor name (same as DE 43)

At block 1040, the MPG provides a response to the ATM switch, containing, among other data elements, the following:
Service (Cash-In/Cash-Out)
Consumer MSISDN
Transaction Amount
Consumer PAN
Consumer PAN Expiration Date
Acquirer ICA

At block 1050, the ATM Switch receives the user authentication response from the MPG, including the accountholder PAN.

When the transaction is approved, the ATM Switch formulates the payment transaction and submits it to the Issuer via the payment network for authorization, block 1060. The issuer may be identified from the first six digits of the accountholder PAN, the first six digits also referred to as an issuer identification number (IIN). The first Issuer will authorize the transaction and return a response to the ATM switch.

At block 1070, the ATM Switch sends a confirmation message to the ATM.

The ATM displays the message to the accountholder on the user interface, block 1080.

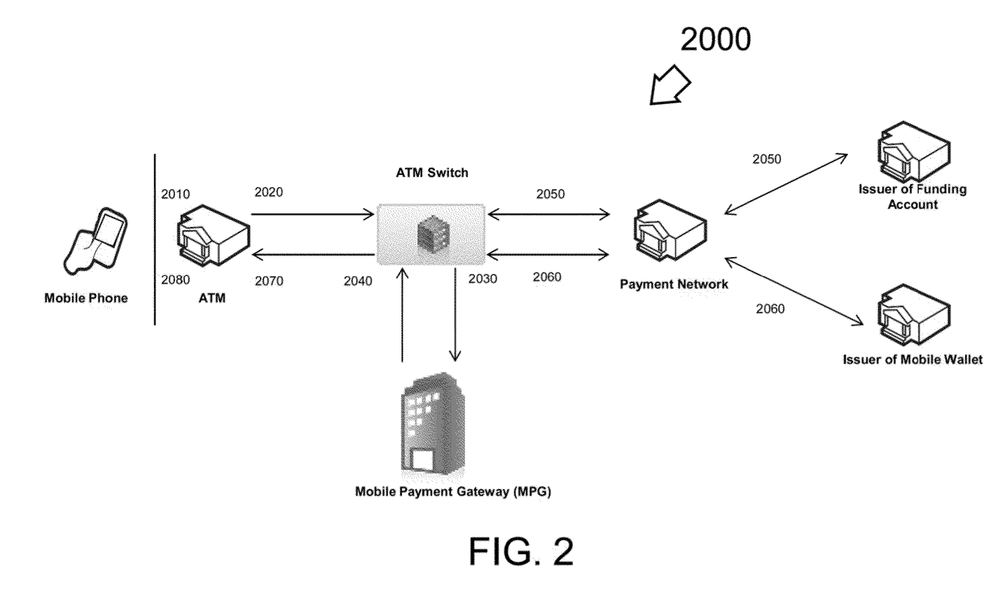

FIG. 2 illustrates method 2000 of authenticating a user in which a mobile phone at ATM uses an Account Value Load (AVL) deposit, constructed and operative in accordance with an embodiment of the present disclosure. Method 2000 facilitates a deposit into a different account (an account to account transaction, for example, a MasterCard MoneySend® or Visa OCT transaction), accomplished as a funding leg and a payment leg. For illustrative purposes only, we will describe this as a funding account (from which the funds come from), and a mobile wallet account (from which the funds will go to). It is understood by those familiar with the art, that a variety of different types of accounts may be used.

At block 2010, a consumer at an ATM selects “Load funds into Mobile Wallet using funding account.” This may be accomplished by inserting the funding ATM card (associated with the funding account) into the ATM and keying in the m-PIN of the funding account. The consumer then enters their mobile phone number, m-PIN and the amount that needs to be transferred into the mobile wallet from the funding account.

The ATM machine submits the information to the ATM switch, block 2020.

The ATM switch submits a cash-in request to the MPG platform, block 2030.

The ATM switch receives the user authentication response from the MPG, including the consumer PAN and card expiration date, and passes it to the ATM acquirer, block 2040.

The acquirer formulates the funding payment transaction using the funding account information, submits it to the Issuer of the funding account via the payment network, and receives a response, block 2050. The funding transaction may be sent as an ISO funding construct, defined by ISO 8583. The ISO message construct for the funding transaction may be:

DE 3 s1=00

DE 18=6538

DE 22 SF 1=PAN auto-entry

DE 48 (TCC)=R

DE 48 SF 23=00 (Card)

DE 48 SF 48

N/A

DE 61

SF 4 (POS Accountholder Presence)=0 (Accountholder Present)

SF 5 (POS Card Presence)=0 (card present)

SF 6 (POS Card Capture=1 (card capture capability)

SF 10 (CAT Level)=1 (ATM)

When the issuer approves the funding, ATM switch sends an account-to-account payment transaction ((for example, a MasterCard MoneySend® or Visa OCT message) to credit the wallet to Issuer of the mobile wallet and receives a response. The Issuer will authorize the transaction and return a response to the ATM switch, block 2060. The ISO construct for the payment transaction may be:

DE 3 s1=28

DE 18=6536/6537

DE 22 SF 1=82 (PAN auto-entry via server)

DE 48 (TCC)=P

DE 48 SF 23=01 (Mobile Phone or smartphone)

DE 48 SF 48
SE 1=1 or 2
SE 2=currently defined as 09

DE 48 SE 77 (Payment Transaction Type)=C52

DE 61
SF 3 (Terminal Location)=2 (off premises)
SF 4 (POS Accountholder Presence)=5 (ecommerce)
SF 5 (POS Card Presence)=1 (card not present)
SF 6 (POS Card Capture=0 (no card capture cap.)
SF 10 (CAT Level)=6 (ecommerce)

DE 124=If Sender name is unknown use card acceptor name (same as DE 43)

At block 2070, the acquirer, via the ATM switch, will send the message to the ATM machine.

The ATM user interface confirms the deposit to the Consumer, block 2080.

Mobile at ATM for Cash-Out (Withdrawals)

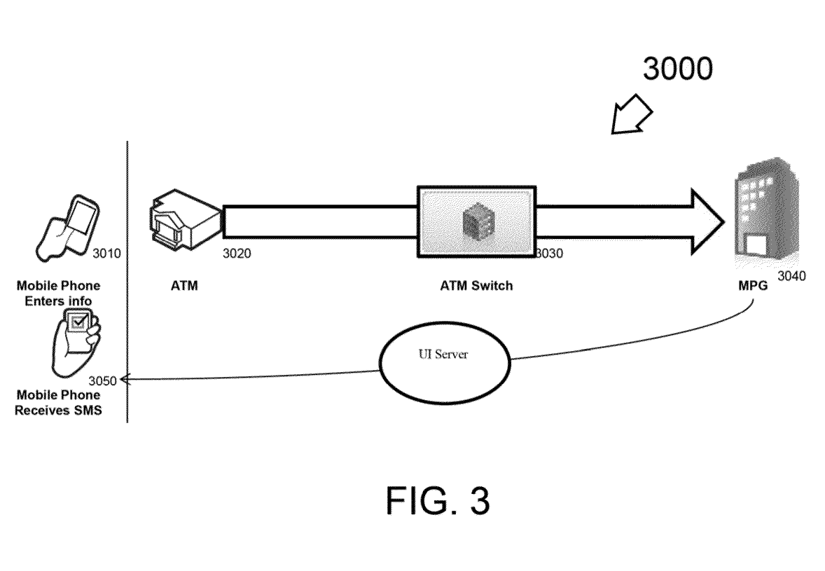

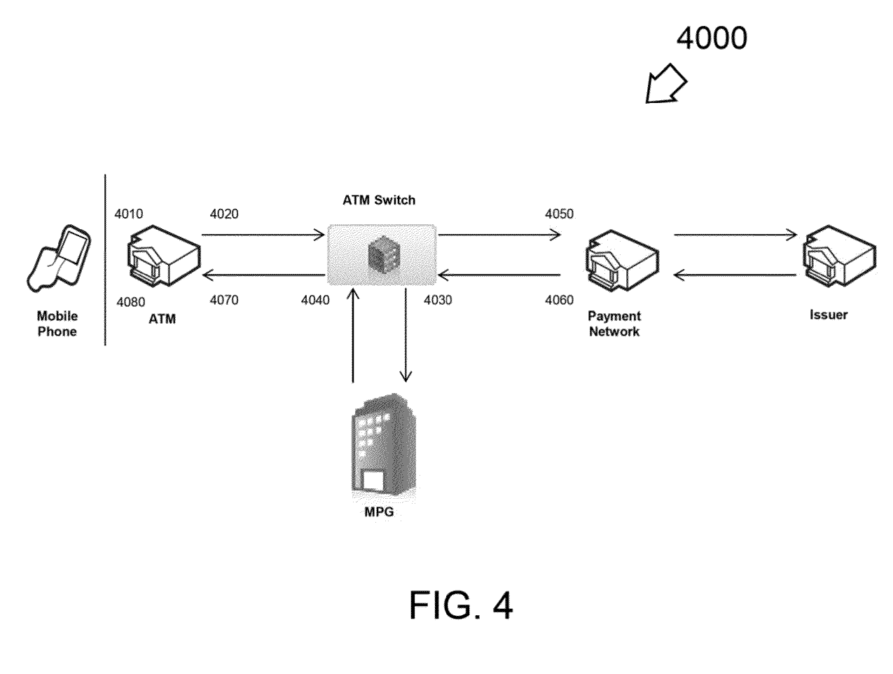

Embodiment payment network offers accountholders the ability to cash-out (withdraw) funds from their mobile prepaid wallet using ATMs where the payment network mobile acceptance mark is displayed. There are two parts to this process: user authentication and password generation process 3000, shown in FIG. 3, and a withdrawal transaction process, depicted in FIG. 4.

A user authentication and one-time password generation process 3000 is depicted in FIG. 3, constructed and operative in accordance with an embodiment of the present disclosure.

At block 3010, a consumer enters their mobile phone number and a 6 digit m-PIN into the ATM keypad. The ATM machine submits this information to the ATM switch, block 3020. The ATM switch submits a one-time-password request to the MPG platform, block 3030.

The MPG validates the consumer, generates the one-time-password and transmits the one-time-password to a user interface (UI) server, block 3040. The password is only valid for a single use and is available only for a limited time once requested. The user interface server is a server that is configured to send a short message service (SMS) notification to the mobile phone designated by the +6 digit m-PIN.

At block 3050, the consumer receives the one-time-password, via a SMS notification on the mobile phone via the UI server.

In such an embodiment, the ATM cash-out withdrawal transaction utilizes the current ATM card processing network and procedures. The ATM Switch relies upon the MPG to authenticate the consumer's credentials, retrieves the Primary Account Number (PAN) from the MPG, and then submits the withdrawal transaction to the payment network.

The authentication and withdrawal transaction method 4000 is depicted in FIG. 4, constructed and operative in accordance with an embodiment of the present disclosure. It is understood that withdrawal transaction method 4000 takes place after an accountholder obtains a one-time-password. The one-time-password may have been obtained using a process such as method 3000.

At block 4010, the accountholder uses the ATM user interface to make a cash-out request by entering the amount desired, their MSISDN, and the previously generated one time password.

The ATM sends the request to ATM Switch containing, among other data elements, the accountholder's MSISDN, the one-time password, and the amount requested by the accountholder, block 4020.

At block 4030, the ATM Switch submits the Cash-out request to MPG containing, among other data elements, the following:
Service (Cash-In/Cash-Out)
Consumer MSISDN
Consumer One Time Password (OTP)
Ceiling Amount
Acquirer Terminal ID

The MPG receives the request and authenticates the user's OTP. If the authentication is successful, the MPG maps the Consumer's MSISDN to the accountholder's default PAN.

At block 4040, the MPG provides a response to the ATM Switch, containing, among other data elements, the following:
Service (Cash-In or Cash-Out)
Consumer MSISDN
Transaction Amount
Consumer PAN
Consumer PAN Expiration Date
Acquirer ICA

The MPG stores the transaction in the database.

At block 4050, the ATM Switch receives the user authentication response from the MPG, including the consumer PAN, OTP, and Consumer PAN expiration date. The ATM Switch formulates the Cash Withdrawal Message and submits it to the Issuer via the payment network. In some embodiments, the ISO message construct for a cash-out may be:

MTI

DE2=Prepaid PAN

DE3=01

DE4=Normal Data

DE7=Normal Data

DE14=Optional

DE 11=Normal Data

DE12=Normal Data

DE13=Normal Data

DE 18=6011

DE22=820

DE32=Normal Data000000

DE33=Normal Data

DE35—Confirmed track data does not have to be present. The ATM Switch will build the track data and send to the receiver. If a valid expiration date is present, it is part of the track data. Otherwise, the ATM Switch inserts 4912 as the expiration date.

DE41=Normal Data

DE43=Normal Data

DE49=Normal Data

DE52—The ATM Switch must include a PIN to create a properly formatted Cash Withdrawal Message. Since PIN validation occurs between the cardholder/ATM and MPG in this embodiment, the ATM Switch must include a fictitious PIN in the message to the payment network and eventually, the Issuer.

DE61=Normal Data

At block 4060, the Issuer authorizes the transaction and returns a response to the ATM Switch via the payment network.

The ATM Switch sends the message to the ATM, block 4070.

At block 4080, the ATM dispenses the desired amount as cash.

It is understood by those familiar with the art that the system described herein may be implemented in hardware, firmware, or software encoded on a non-transitory computer-readable storage medium. It is further understood that each of the devices depicted in FIGS. 1-4, have respective processors, network interfaces, and non-transitory computer-readable storage medium.

A processor may be any central processing unit, microprocessor, micro-controller, computational device or circuit known in the art. It is understood that processor may communicate with and temporarily store information in Random Access Memory (RAM). Processor may run a multi-tasking operating system (OS), such as Microsoft Windows, Advanced Interactive Executive (AIX™) operating system, UNIX operating system, or LINUX operating system, and the like.

A network interface may be any data port as is known in the art for interfacing, communicating or transferring data across a computer network, examples of such networks include mobile data networks, Transmission Control Protocol/Internet Protocol (TCP/IP), Ethernet, Fiber Distributed Data Interface (FDDI), token bus, or token ring networks. Network interfaces allow each of the devices depicted in FIGS. 1-4 to communicate with each other.

Computer-readable storage medium may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. A method comprising:
receiving a cash deposit request with a network interface, the cash deposit request including a customer Mobile Station International Subscriber Directory Number (MSISDN), a mobile PIN (m-PIN), and an amount of the cash deposit;
formulating, with a processor, an International Standards Organization (ISO) cash-in message construct, the ISO message construct including the MSISDN, the m-PIN, and the amount of the cash deposit;
transmitting the ISO cash-in message to a mobile payments gateway with the network interface;
receiving, with the network interface, a user authentication response from the mobile payments gateway, the user authentication response including: an accountholder Primary Account Number (PAN) associated with the MSISDN and m-PIN;
identifying, with the processor, an issuer identified by the accountholder PAN;
formulating a payment transaction message with the processor, the payment transaction message including: the accountholder PAN, and the amount of the cash deposit;
transmitting, with the network interface, the payment transaction message to the issuer identified by the account PAN.

2. A method comprising:
receiving an Account Value Load (AVL) request with a network interface, the Account Value Load request including a customer Mobile Station International Subscriber Directory Number (MSISDN), a mobile PIN (m-PIN), a receiving account number, and an amount of a deposit;
formulating, with a processor, an International Standards Organization (ISO) funding message construct, the ISO message construct including the MSISDN, the m-PIN, and the amount of the deposit;
transmitting, with the network interface, the ISO funding message to a mobile payments gateway;
receiving, with the network interface, a user authentication response from the mobile payments gateway, the user authentication response including: an accountholder Primary Account Number (PAN) associated with the MSISDN and m-PIN;
identifying, with the processor, a funding issuer identified by the accountholder Primary Account Number;
identifying, with the processor, a receiving issuer identified by the receiving account number;
formulating, with the processor, a funding transaction message, the funding transaction message including: the accountholder PAN, and the amount of the deposit;
formulating, with the processor, a payment transaction message, the payment transaction message including: the receiving account number, and the amount of the deposit;
transmitting, with the network interface, the funding transaction message to the funding issuer identified by the accountholder PAN;
transmitting, with the network interface, the payment transaction message to the receiving issuer identified by the receiving account number.

3. A method comprising:
receiving, with a network interface, a cash-out request from an Automated Teller Machine (ATM), the cash-out request including a customer Mobile Station International Subscriber Directory Number (MSISDN), a mobile PIN (m-PIN), a receiving account number, and an amount of a withdrawal;
matching, with a processor, the MSISDN and m-PIN to a Primary Account Number;
generating, with the processor, a generated one-time password when the MSISDN and m-PIN are matched to the Primary Account Number;
transmitting, with the network interface, the generated one-time password to a mobile phone designated by the MSISDN;
receiving, with the network interface, a confirmation one-time password from the ATM;
confirming, with the processor, that the confirmation one-time password is the same as the generated one-time password;
formulating a cash-out transaction message with the processor when the processor confirms that the confirmation one-time password is the same as the generated one-time password, the cash-out transaction message including: the accountholder PAN, and the amount of the cash withdrawal;
transmitting, with the network interface, the cash-out transaction message to an issuer identified by the account PAN;
transmitting, with the network interface, a cash-out transaction authorization to the ATM when the issuer sends an issuer authorization, otherwise transmitting a decline message to the ATM.
